(19) United States
(12) Patent Application Publication
(10) Pub. No.: US 2002/0025030 A1
(43) Pub. Date: Feb. 28, 2002

(54) Method for identifying calling party number and calling back in switching system

(75) Inventor: In Soo Kim, Kyungki-Do (KR)

Correspondence Address: FLESHNER & KIM, LLP, P.O. Box 221200, Chantilly, VA, 20153-1200, US

(73) Assignee: LG Electronics Inc.

(21) Appl. No.: 09/837,298

(22) Filed: Apr. 19, 2001

(30) Foreign Application Priority Data
Apr. 20, 2000 (KR) 21319/2000

(51) Int. Cl. H04M 3/42

(52) U.S. Cl. 379/210.01

(57) ABSTRACT

A method for identifying a calling party number of a switching system includes the steps of: checking whether a termination subscriber has registered for a calling party number call-back service when a call set-up is requested; storing the terminated calling party number of an origination subscriber if the termination subscriber has registered for the calling party number call-back service; and announcing the stored calling party number if a calling party number confirming request is received from the termination subscriber. With this method, a calling party number is automatically identified and calling back the origination subscriber can be performed by simple code inputting.

### BACKGROUND OF THE INVENTION

1. Field of the Invention

The present invention relates to a switching system, and more particularly, to a method for identifying a calling party number and calling back in a switching system.

2. Description of the Background Art

FIG. 1 illustrates a basic structure of a general switching system.

Referring to FIG. 1, the switching system includes an ASS (Access Switching Subsystem) 1 for performing interfacing between a subscriber and a trunk line or a distributed call process function such as a call origination and call terminal, an INS (Interconnection Network Subsystem) 2 positioned at the center of the system for connecting ASSs 1 or a CCS 3 and the ASS 1, and the CCS (Central Control Subsystem) 3 for performing general control, operation and maintenance function of the system.

The ASS 1 includes a matching unit for matching the subscriber and the trunk line, a time switch and various signal devices, to perform a distributed call processing function. The ASS 1 has a horizontally distributed structure over the INS 2, and 32 ASSs 1 at the maximum can be connected to the INS 2.

The INS 2 performs the number translation function (prefix translation and termination number translation), a route controlling function, a space switch connection function and storing and managing function of subscriber information. Thus, blocks which perform the common function of a call processing such as routing and switching function are positioned in the INS 2.

The CCS 3 performs interworking function with other systems such as functions of maintenance and operation managing at the system level, statistics function, a mass storage controlling and managing function, and operator instruction word controlling function.

The operation of the switching system constructed as described above will now be explained with reference to the accompanying drawings.

When a call request is generated from a subscriber, the ASS 1 requests information on the origination subscriber from the INS 2. When information on the origination subscriber is received, the ASS 1 performs a necessary originating call service function and requests the number translation from the INS 2.

The INS 2 translates the number, searches and connects a speech path and sets a talking path, and a terminating ASS (not shown) performs a terminating call service function.

Thereafter, as the call is completed, the originating and terminating ASSs return a call data to an idle state, and the originating ASS 1 informs the CSS 3 of a charging data.

In case where the ASS 1 and the INS 2 are broken down, the troubled state is informed the CCS 3, so that the operation and maintenance function can be performed at the system level, and the CCS 3 transmits a corresponding instruction to the related ASS 1 or INS 2.

The phone number (called ‘digit’, hereinafter) dialed by the subscriber is a key to trace a termination, signifying that the origination subscriber designates a specific termination subscriber. Thus, according to translation of the phone number, it is determinated that to which line a call is to be terminated or to which terminating remote station the call is to be outgoing.

FIGS. 2 and 3 are drawings illustrating a related art call processing procedure according to a method for identifying a calling party number.

With reference to FIG. 2, when a call is generated from the subscriber, a origination processing unit 10 is allocated with an idle resource to connect the dial tone. When the dial tone is connected, the originating call processing unit 10 collects digits (i.e., three digits, etc.) required for the number translation from a subscriber terminal.

After the required digits are collected, the origination processing unit 10 requests a number translation unit 20 to translate the number through an IPC link, and the number translation unit 20 searches an prefix table in a point-to-point method by using the received digits as a key and discriminates a call type.

Upon discrimination, if the corresponding call is an intra-office call, the number translation unit 20 requests a terminating occupation from a termination processing unit 30, and then, the termination processing unit 30 checks whether the termination subscriber has registered for a calling party number display function.

Upon checking, if the corresponding termination subscriber has registered for the calling party number display function, the termination processing unit 30 requests the calling party number from the origination processing unit 10.

Thereafter, when the calling party number is informed from the origination processing unit 10, the termination processing unit 30 transmits the calling party number to the calling party number receiving terminal 40 by using a DTMF signal as well as transmitting a ring signal to a termination terminal 50.

Meanwhile, according to the result of the number translation, if the call is a call from a different station, as shown in FIG. 3, the termination processing unit 30 requests a calling party number from an incoming trunk processing unit 60. In case that there exists the requested calling party number in an originating ststion 70, the incoming processing unit 60 reports the corresponding calling party number to the termination processing unit. If the requested calling party number does not exist, the incoming trunk processing unit 60 receives the calling party number directly from the subscriber terminal and informs the termination processing unit 30 of it.

Then, the terminating call processing 30 transmits the DTMF signal to the calling party number receiving apparatus 40 of the termination subscriber as well as transmitting a ring signal to the termination terminal 50. Accordingly, the calling party number transmitted to the termination subscriber is displayed on a display unit of the calling party number receiving apparatus 40.

The method for identifying a calling party number according to the related art has various problems. For example, in order for the termination subscriber identify the terminated calling party number, his or her terminal should additionally include a calling party number receiving apparatus. In addition, in case where the termination subscriber calls back with the terminated calling party number, the termination subscriber should identify the calling party number displayed on the calling party number receiving apparatus and perform dialing operation.

The above references are incorporated by reference herein where appropriate for appropriate teachings of additional or alternative details, features and/or technical background.

### SUMMARY OF THE INVENTION

Therefore, an object of the present invention is to provide a method for identifying a calling party number and calling back in a switching system that is capable of automatically identifying of a calling party number and calling back by simple code inputting.

To achieve at least the above objects in whole or in parts, there is provided a method for identifying a calling party number of a switching system comprising the steps of: checking whether a termination subscriber has registered for a calling party number call-back service when a call set-up is requested; storing the terminated calling party number of an origination subscriber if the termination subscriber has registered for the calling party number call-back service; and announcing the stored calling party number if a calling party number confirming request is received from the termination subscriber.

To achieve at least these advantages in whole or in parts, there is further provided a method for identifying a calling party number and calling back in a switching system including the steps of: checking whether a termination subscriber has registered for a calling party number call-back service when a call set-up is requested by an origination subscriber; storing the terminated calling party number of an origination subscriber if the termination subscriber has registered for the calling party number call-back service; announcing the stored calling party number in response to a calling party number confirming request from the termination subscriber; and calling back the origination subscriber with the stored calling party number when the calling party number call-back request is inputted.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing illustrating a basic structure of a general switching system;

FIGS. 2 and 3 are drawings illustrating a related art call processing of a method for identifying a calling party number of a switching system;

FIG. 4 is a flow chart of a method for identifying a calling party number and calling back in a switching system in accordance with a preferred embodiment of the present invention;

FIG. 5 is a flow chart of a process of storing the calling party number of FIG. 4 in accordance with the present invention;

FIG. 6 is a drawing illustrating a call processing for storing a calling party number in case that a call requested by the origination subscriber is an intra-office call of FIG. 5 in accordance with the preferred embodiment of the present invention;

FIG. 7 is a drawing illustrating a call processing for storing the calling party number in case that a call requested by the origination subscriber is an inter-office call of FIG. 5 in accordance with the preferred embodiment of the present invention;

FIG. 8 is a flow chart of a process of identifying the calling party number of FIG. 4 in accordance with the preferred embodiment of the present invention;

FIG. 9 a drawing illustrating a call processing for performing the process of identifying the calling party number of FIG. 8 in accordance with the preferred embodiment of the present invention;

FIG. 10 is a flow chart of a process of calling back with the calling party number of FIG. 4 in accordance with the preferred embodiment of the present invention; and

FIG. 11 is a drawing illustrating a call processing for performing the process of calling back with the calling party number of FIG. 8 in accordance with the preferred embodiment of the present invention.

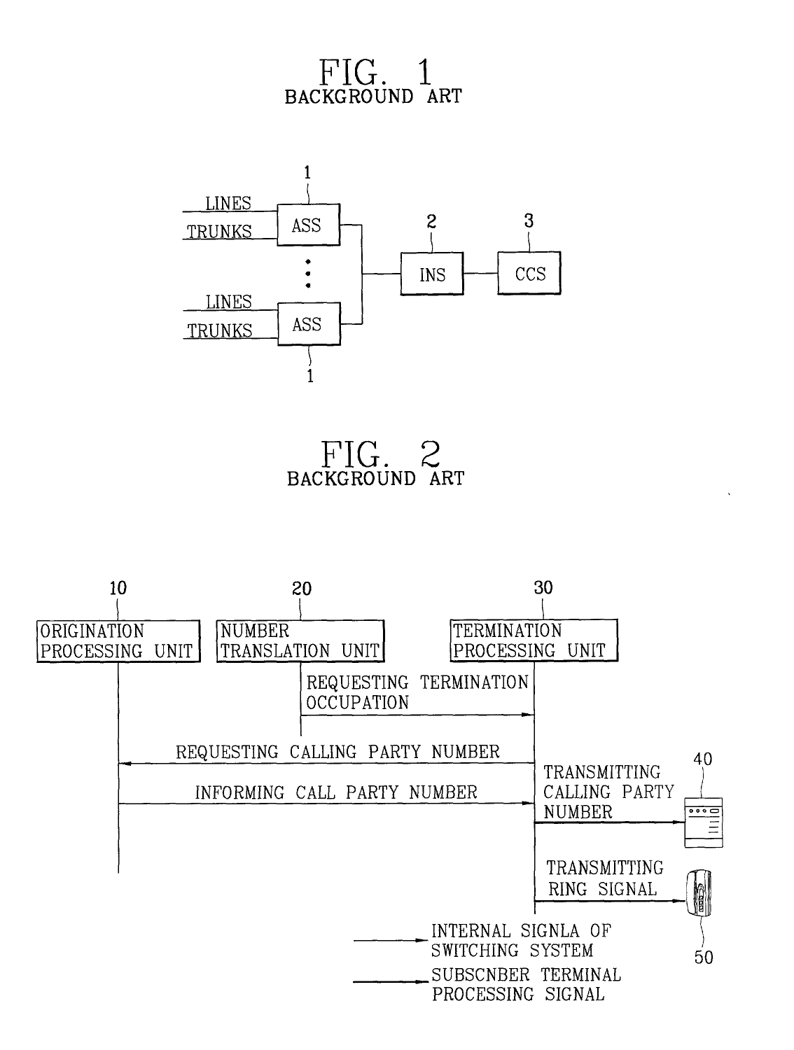

### DETAILED DESCRIPTION OF THE PREFERRED EMBODIMENTS

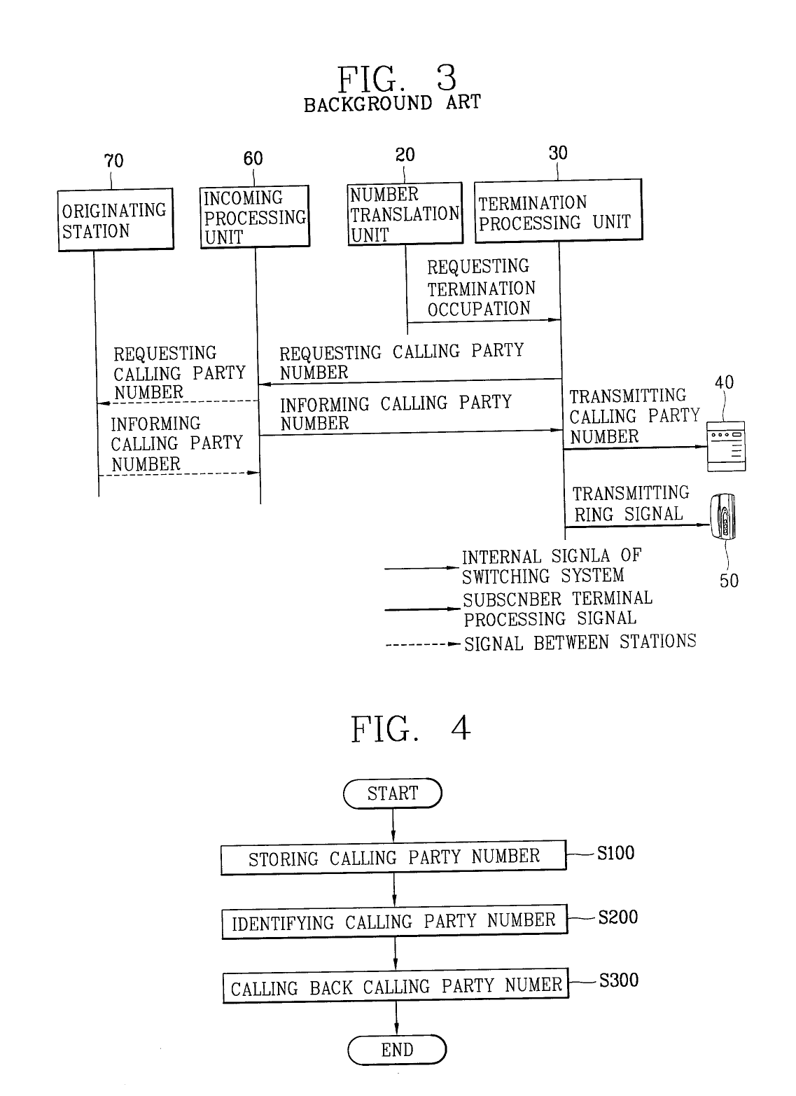

FIG. 4 is a flow chart of a method for identifying a calling party number and calling back in a switching system in accordance with the present invention.

As shown in FIG. 4, after a terminated calling party number of an origination subscriber is stored in a data base (DB) (S100), the calling party number stored in the DB is announced in response to the a calling party number confirming request of a termination subscriber (S200) or the origination subscriber is called back by using the calling party number stored in the DB (S300).

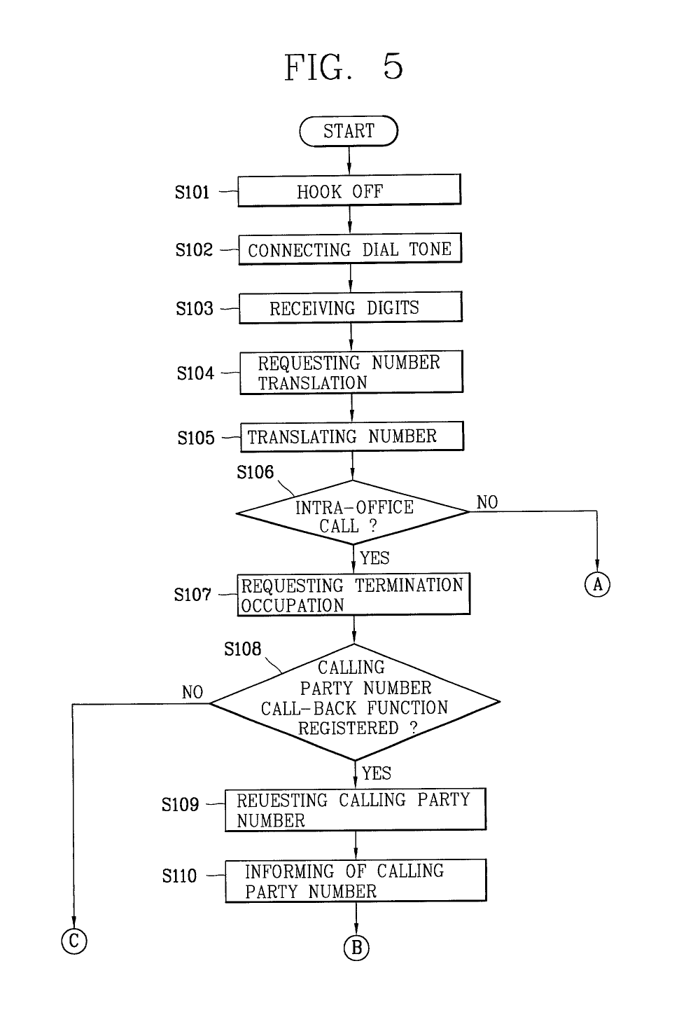

FIG. 5 is a flow chart of a process of storing the calling party number of FIG. 4 in accordance with the present invention.

As shown in FIG. 5, when the origination subscriber hooks off a terminal, the origination processing unit 100 is allocated with an idle resource to connect the dial tone and receives a predetermined number of digits from the origination subscriber (S101-S103).

After receiving the predetermined number of digits, the origination processing unit 100 requests the number translation through a IPC link from a number translation unit 200 (S104), and the number translation unit 200 searches an prefix table in a point-to-point method by using the received digits as a key and discriminates a call type (S105).

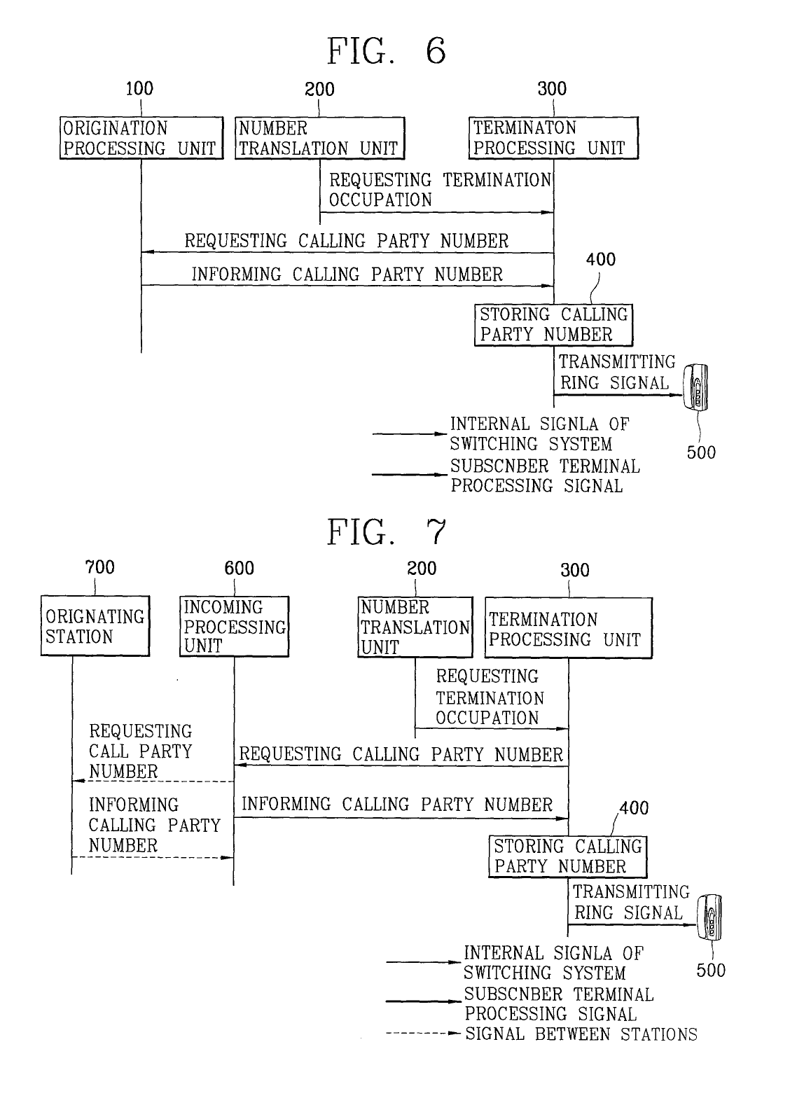

Upon discrimination, if the corresponding call is an intra-office call, the number translation unit 200 requests a terminating occupation from a termination processing unit 300 (S106, S107), and then, the termination processing unit 30 checks whether the termination subscriber has registered for a calling party number call-back function (S108). Upon checking, if the corresponding termination subscriber has registered for the calling party number call-back function, the termination processing unit 300 requests a calling party number from the originating call processing unit 100 as shown in FIG. 6, and then, when the termination processing unit 300 is informed of the calling party number as requested, it judges whether the switching system of an intra-office is a multi-station (S109˜S111).

If the intra-office switching is judged to be a multi-station, the termination processing unit 300 compares the area code of the calling party number informed by the origination processing unit with the area code of the intra-office to check whether the two codes are identical to each other (S112).

If the two area codes are identical to each other, the calling party number except the area code is stored in the database (DB) 400. But if the two area codes are different to each other, the calling party number and the area code are all stored in the DB 400 (S113, S114).

Thereafter, as the calling party number is completely stored, the termination processing unit 300 transmits the ring signal to the terminal of the termination subscriber likewise in the related art (S116). If the termination terminal 500 is busy, the calling party number is not stored. Meanwhile, if the switching system of an intra-office is a single station, the termination processing unit 300 stores the calling party number informed by the origination processing unit 100 as it is (S115).

Meanwhile, if the call requested in the step S106 is an inter-office call, the number translation unit 200 requests a terminating occupation from the termination processing unit 300 (S117). In response to the terminating occupation request, the termination processing unit 300 checks whether the termination subscriber has registered for the calling party number call-back service (S118).

Upon checking, if the termination subscriber has registered for the calling party number call-back service, as shown in FIG. 7, the termination processing unit 300 requests a calling party number from an incoming trunk processing unit 600 (S119).

If the incoming trunk processing unit 600 contains the requested calling party number, it informs the termination processing unit 300 of the corresponding calling party number (S120, S121). If the incoming trunk processing unit 600 does not contain the requested calling party number, it receives the calling party number directly from a originating station 700 and informs the termination processing unit 300 of it (S122).

Then, the termination processing unit 300 changes the calling party number informed by the incoming relay processing unit 600 to an area code inclusive of ‘0’ and compares the changed area code with the area code of its own station to check whether they are identical to each other (S123, S124).

Upon comparison, if the two area codes are identical to each other, the termination processing unit 300 stores the calling party number except the area code in the data base (DB) 400 (S126).

Thereafter, as the calling party number is completely stored, the termination processing unit 300 transmits a ring signal to the termination terminal 500 (S127). In this respect, if the termination terminal 500 is busy, the termination processing unit 300 does not store the calling party number.

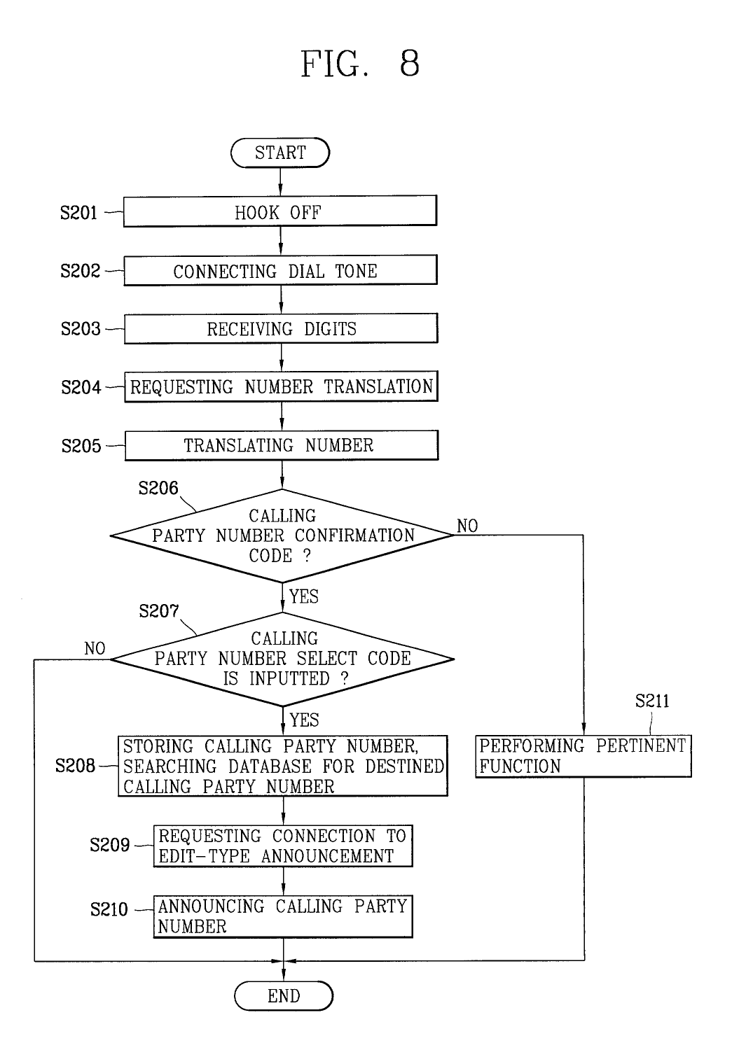

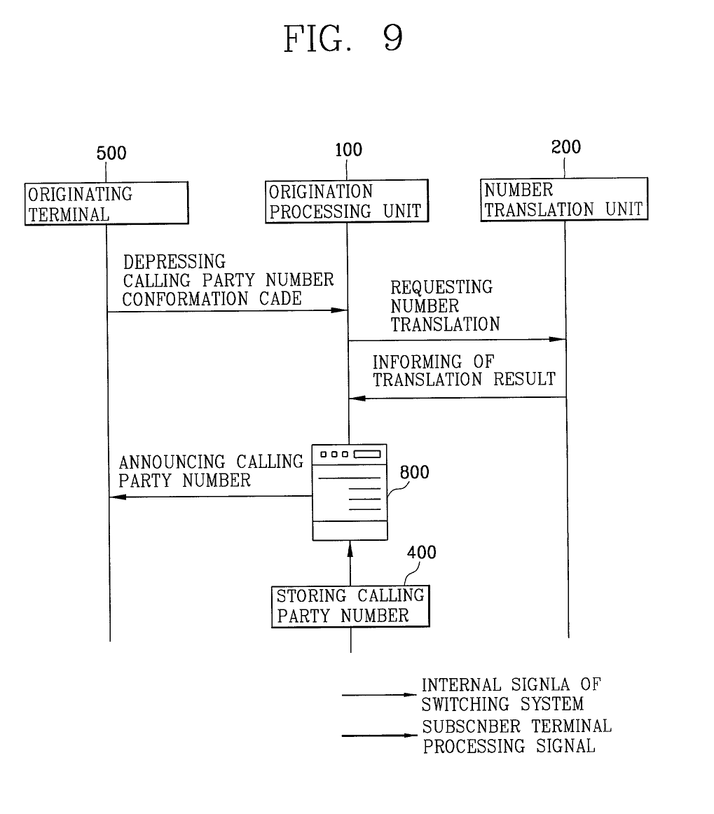

FIG. 8 is a flow chart of a method for identifying a calling party number, and FIG. 9 illustrates a call processing for performing the process of identifying the calling party number of FIG. 8 in accordance with the present invention.

As shown in FIGS. 8 and 9, when the termination subscriber hooks off the originating terminal 500, the origination processing unit 100 is allocated with an idle resource and connects a dial tone (S201, S202). In this state, when the termination subscriber inputs a calling party number confirmation code (i.e., #05, etc.), the origination processing unit 100 receives the digits from the origination subscriber and requests a number translation from the number translation unit 200 (S203, S204).

According to the result of the number translation, if the input code is a calling party number confirmation code, the origination processing unit 100 searches a calling party number storing table of the DB 400 to find out the calling party number terminated to the termination subscriber (S205˜S207) and requests an edit-type announcement (S208).

In response to the request from the origination processing unit 100, an announcement controller 800 makes a voice announcement of the plurality of calling party numbers to the termination subscriber (S209). In this case, a selective announcement (i.e., ‘would you like to select this number?’, etc.) which allows users to select a specific calling party number is additionally announced along with the announcement of each calling party number so that the origination subscriber can call back with a desired calling party number (S210).

Accordingly, when the termination subscriber listens to the selective announcement and inputs a calling party number select code (Yes or No), the origination processing unit 100 calls back the origination subscriber with the calling party number corresponding to the inputted select code.

Without being restricted to the announcement, a plurality of calling party numbers can be displayed on a display unit. In this case, the calling party number is displayed in voice or visually according to a form of a termination terminal.

In the case where the plurality of calling party numbers are displayed, a sequential number is assigned to each displayed calling party number, so that the termination subscriber inputs the serial number (a calling party number selection code) assigned to each calling party number. Accordingly, the origination processing unit 100 senses the input of the calling party number selection code from the termination subscriber and calls back the origination subscriber with the calling party number corresponding to the corresponding code.

Meanwhile, in the step S206, if the input code is not the calling party number confirmation code, the origination processing unit 100 performs a pertinent function (S210).

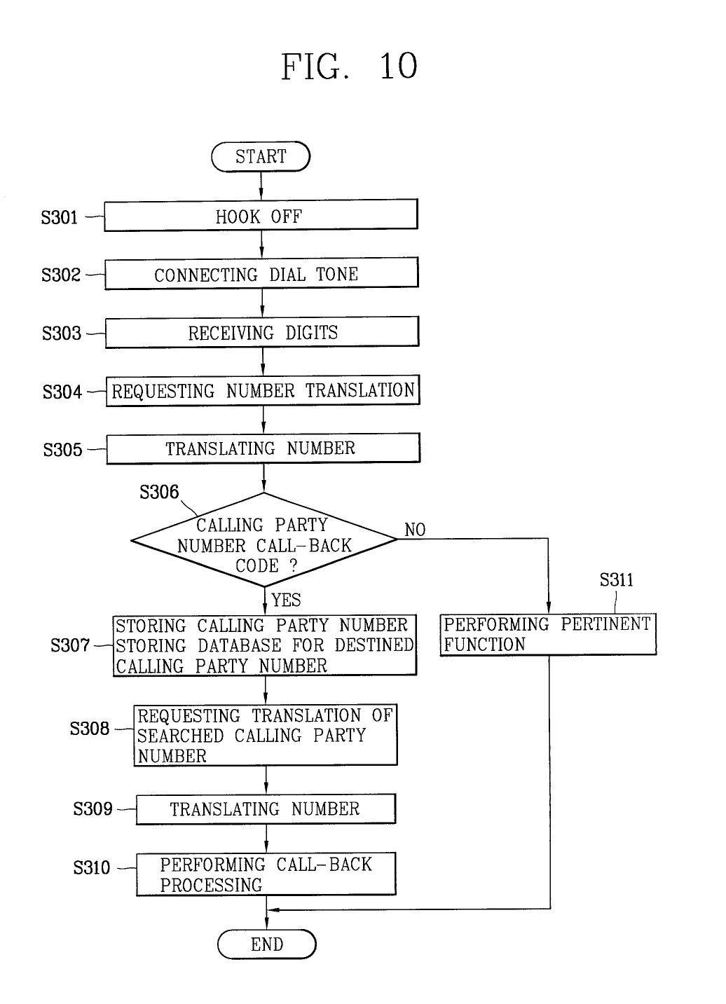

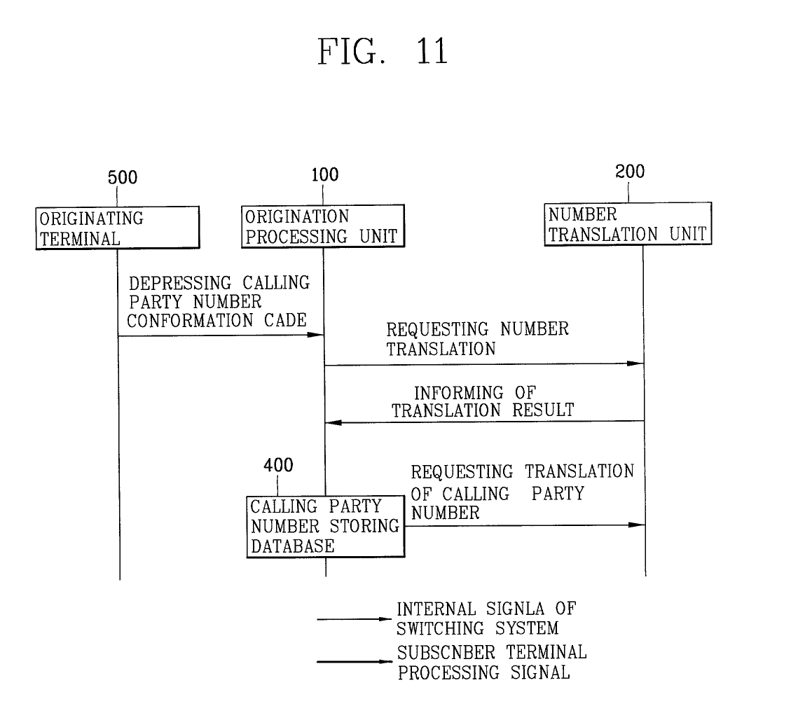

FIG. 10 is a flow chart of a process of calling back the calling party number of FIG. 4, and FIG. 11 illustrates a call processing for performing the process of calling back the calling party number of FIG. 8 in accordance with the present invention.

As shown in FIGS. 10 and 11, when the termination subscriber hooks off the originating terminal 500 and inputs a calling party number call-back code (i.e., #06, etc.), the origination processing unit 100 receives digits from the origination subscriber and requests a number translation from the number translation unit 200 (S301˜S305).

According to the result of the number translation, if the input code is a calling party number call-back code, the origination processing unit 100 checks whether a calling party number selection code is inputted from the termination subscriber (S306).

When the calling party number selection code is inputted from the termination subscriber, the origination processing unit 100 searches the calling party number storing table of the DB 400 for a calling party number corresponding to the calling party number selection code and requests translation of the pertinent calling party number from the number translation unit 200.

Then, the number translation unit 200 translates the received digits (the calling party number), discriminates the call type and requests a terminating occupation from the termination processing unit 300 according to the call type, so that the termination processing unit 300 calls back the origination subscriber through the general call processing.

FIG. 12 is an overall flow chart of method for identifying a calling party number and calling back.

As shown in FIG. 12, when the termination subscriber who has registered for the calling party number call-back service inputs a calling party number confirmation code, the series of processes (S401˜S409) as described above are sequentially performed, so that the calling party numbers of the origination subscribers terminated to the termination subscriber are announced in voice or visually displayed.

Thereafter, when the termination subscriber recognizes an announcement type or a desired calling party number of an origination subscriber among the displayed calling party number and inputs the calling party number call-back code and the calling party number selection code for select and a specific calling party number, the origination processing unit 100 performs the series of processes (S410˜S417) to call back the origination subscriber.

Without being restricted to the plurality of dial numbers, in the preferred embodiment of the present invention, the finally terminated calling party number may be solely stored, and then, when the calling party number call-back code is inputted from the termination subscriber, it is possible to call back the origination subscriber with the stored calling party number.

The preferred embodiment of the present invention describes the operation of identifying a calling party number and calling back for a call which is answered (that is, a call is set up). However, in the present invention, even for a call which is not answered (that is, a call is not set up), the operation of identifying the number of an origination subscriber and calling back can be performed with the same procedure.

As so far described, according to the method for identifying a calling party number and calling back in a switching system of the present invention, a terminated calling party number of an origination subscriber is stored, announced and used to call back according to a predetermined instruction. Thus, without an additional calling party number receiving apparatus, the calling party number can be identified. Besides, it is possible to call back the origination subscriber of the terminated calling party number by simple code inputting.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, mans-plus-function clauses are intended to cover the structure described herein as performing the recited function and not only structural equivalents but also equivalent structures.

What is claimed is:

1. A method for identifying a calling party number of a switching system comprising the steps of:
checking whether a termination subscriber has registered for a calling party number call-back service when a call set-up is requested;
storing the terminated calling party number of an origination subscriber if the termination subscriber has registered for the calling party number call-back service; and
announcing the stored calling party number if a calling party number confirming request is received from the termination subscriber.

2. The method of claim 1, wherein the step of a calling party number comprises:
requesting a calling party number from the origination processing unit if the requested call is an intra-office call;
checking whether an switching system of an intra-office is a single station when the calling party number is informed; and
storing the calling party number informed by the origination processing unit in a data base if the switching system of an intra-office is a single station

3. The method of claim 1, wherein the calling party number is not stored if the termination terminal is busy.

4. The method of claim 1, wherein the step of storing a calling party number comprises:
requesting a calling party number from the origination processing unit if the requested call is an intra-office call;
checking whether a switching system of the intra-office is a multi-station when the calling party number is informed;
comparing an area code of the calling party number informed by the origination processing unit and an area code of its own office if the switching system of the intra-office is a multi-station; and
storing only the calling party number if the two area codes are identical to each other, or storing both the area code and the calling party number if the two area codes are different to each other.

5. The method of claim 1, wherein the step of storing a calling party number comprises:
requesting the calling party number from the incoming processing unit if the requested call is an inter-office call;
comparing the area code of the calling party number informed by the incoming trunk processing unit with the area code of its own office; and
storing only the called party number if the two area codes are identical to each other, or storing both area code and the calling party number if the two area codes are not identical to each other.

6. The method of claim 1, wherein the step of announcing a calling party number comprises:
sensing input of a code from a termination subscriber;
checking whether the sensed code is a code for confirming the calling party number; and
announcing the calling party number of the origination subscriber stored in the memory in a predetermined form to the termination subscriber if the sensed code is a calling party number confirmation code.

7. The method of claim 6, wherein the predetermined form refers to a voice announcement or a display form.

8. The method of claim 7, wherein in case that the announcement is made in a voice, a selection broadcast which allows selection of each calling party number is additionally outputted.

9. The method of claim 7, wherein when the calling party numbers are displayed on a display unit, each calling party number is assigned with a number sequentially.

10. A method for identifying a calling party number and calling back in a switching system, comprising:
checking whether a termination subscriber has registered for a calling party number call-back service when a call set-up is requested by an origination subscriber;
storing the calling party number of an origination subscriber if the termination subscriber has registered for the calling party number call-back service;
announcing the stored calling party number in a predetermined form when a calling party number confirmation request is inputted from the termination subscriber; and
calling back the origination subscriber with the calling party number when the calling party number call-back request is inputted from the termination subscriber.

11. The method of claim 10, wherein the step of storing a calling party number comprises:
requesting a calling party number from the origination processing unit if the requested call is an intra-office call;
checking whether an switching system of an intra-office is a single station when the calling party number is informed; and
storing the calling party number informed by the origination processing unit in a data base if the switching system of an intra-office is a single station

12. The method of claim 11, further comprising:
comparing an area code of the calling party number informed by the origination processing unit and an area code of its own office if the switching system of the intra-office is a multi-station; and
storing only the calling party number if the two area codes are identical to each other, or storing both the area code and the calling party number if the two area codes are different to each other.

13. The method of claim 10, wherein the step of storing the calling party number comprises:
requesting the calling party number from the incoming processing unit if the requested call is an inter-office call;
comparing the area code of the calling party number informed by the incoming processing unit with the area code of its own office; and
storing only the called party number if the two area codes are identical to each other, or storing both area code and the calling party number if the two area codes are not identical to each other.

14. The method of claim 10, wherein the step of announcing the calling party number comprises:
sensing input of a code from a termination subscriber;
checking whether the sensed code is a code for confirming the calling party number; and
outputting the calling party number of the origination subscriber stored in the memory as an announcement or in a display form if the sensed code is a calling party number confirmation code.

15. The method of claim 14, wherein when the calling party number is broadcast, a selection broadcast is additionally outputted to select a calling party number being currently broadcast.

16. The method of claim 14, wherein when the calling party numbers are displayed, they are respectively assigned with a sequential number.

17. The method of claim 10, wherein the step of calling back with a calling party number comprises:
sensing a code input from a termination subscriber;
checking whether the sensed code is a code for calling back with a calling party number;
sensing receipt of a calling party number selection code if the sensed code is the calling party number call-back code; and
searching a memory region for a calling party number corresponding to a pertinent code and calling back the origination subscriber when the calling party number selection code is inputted.

18. A method for calling back with a calling party number of a switching system, comprising:
checking whether a termination subscriber has registered for a calling party number call-back service when a call set-up is requested;
storing the terminated calling party number of an origination subscriber if the termination subscriber has registered for the calling party number call-back service in a database; and
calling back the origination subscriber with the finally terminated calling party number when a calling party number call-back request is inputted from a termination subscriber.

19. The method of claim 18, wherein the step of storing a calling party number comprises:
requesting a calling party number from the origination processing unit if the requested call is an intra-office call;
checking whether an switching system of an intra-office is a single station when the calling party number is informed;
storing the calling party number informed by the origination processing unit in a data base if the switching system of an intra-office is a single station;
comparing an area code of the calling party number informed by the origination processing unit and an area code of its own office if the switching system of the intra-office is a multi-station; and
storing only the calling party number if the two area codes are identical to each other, or storing both the area code and the calling party number if the two area codes are different to each other.

20. The method of claim 18, wherein the step of storing a calling party number comprises:
requesting the calling party number from the incoming processing unit if the requested call is an inter-office call;
comparing the area code of the calling party number informed by the incoming trunk processing unit with the area code of its own office; and
storing only the called party number if the two area codes are identical to each other, or storing both area code and the calling party number if the two area codes are not identical to each other.
